(19) United States
(12) Patent Application Publication
(10) Pub. No.: US 2026/0307639 A1
(43) Pub. Date: Oct. 8, 2026

(54) METHOD AND SYSTEM FOR PROVIDING A WAKE-UP PEDAL FUNCTION FOR A VEHICLE

(71) Applicant: Robert Bosch GmbH, Stuttgart (DE)

(72) Inventors: Achim Frech, Talheim (DE); Florian Haag, Ellhofen (DE); Martin Marquart, Ludwigsburg (DE); Nikolas Loeffelmann, Dielheim (DE)

(21) Appl. No.: 19/631,133

(22) Filed: Mar. 27, 2026

(30) Foreign Application Priority Data
Apr. 7, 2025 (DE) 10 2025 113 580.0

(51) Int. Cl. B60T 17/22; B60T 7/04

(52) U.S. Cl. CPC B60T 17/221; B60T 7/042; B60T 2270/406; B60T 2270/413

(57) ABSTRACT

A method and system for providing a wake-up pedal function for a vehicle. The method includes: detecting whether a switching command, triggered by a wake-up pedal function of a pedal, for switching on control devices of the vehicle is based on an actuation of the pedal by a driver of the vehicle; and calibrating the wake-up pedal function if it is detected at least once that the triggered switching command is not based on an actuation of the pedal by the driver of the vehicle.

### CROSS REFERENCE

The present application claims the benefit under 35 U.S.C. § 119 of Germany Patent Application No. DE 10 2025 113 580.0 filed on Apr. 7, 2025, which is expressly incorporated herein by reference in its entirety.

### FIELD

The present disclosure relates to a method and a system for providing a wake-up pedal function for a vehicle, in particular an automatic recalibration of a wake-up on pedal function for a brake pedal.

### BACKGROUND INFORMATION

Germany Patent Application No. DE 10 2013 204 702 A1 relates to an apparatus for detecting a pedal actuation of a vehicle pedal when the CAN is asleep, characterized by a switching means arranged on the pedal, which is supplied with a voltage that is permanently active, and which is connected, via at least one contact element, directly to a control device which has a connection to the CAN, wherein an actuation of the switching means by pedal actuation leads to the CAN being woken up by the control device.

Germany Patent Application No. DE 10 2020 213 414 A1 describes a method for controlling a hydraulic brake system with a master brake cylinder, a linear actuator, a hydraulic pump and at least one wheel brake, wherein the hydraulic brake system is awakened from a rest state by exerting a force on the master brake cylinder, in particular by actuating a brake pedal.

Germany Patent Application No. DE 11 2021 005 006 T5 describes a vehicle braking system, in which the structure required when a wake-up signal is transmitted in response to a pedal input can be further simplified, wherein the vehicle braking system comprises: a pedal travel sensor (PTS) which detects whether pressure is applied to the pedal and how high the applied pressure is; and a wake-up detection circuit which is connected to the PTS so that current can flow directly in both directions and which receives a signal from the PTS and wakes up an electronic control unit (ECU), wherein the PTS provides the output signal to the wake-up detection circuit when the output signal has at least one preset value.

Germany Patent Application No. DE 10 2022 209 298 A1 describes a sensor arrangement for a vehicle, comprising an inductive travel sensor configured to ascertain the current position of a moving body and a magnetic sensor configured to detect a starting position of the moving body, wherein the inductive travel sensor comprises at least one movable coupling apparatus coupled to the moving body, which has at least one electrically conductive coupling element and comprises at least one stationary circuit carrier, wherein at least one excitation structure (and at least one receiving structure) are arranged on the at least one circuit carrier, which extends along a movement path of the at least one coupling apparatus between a start position and a target position, wherein a first evaluation and control unit is configured to evaluate at least one measurement signal induced in the at least one receiving structure and to ascertain the current position of the at least one coupling apparatus and of the moving body, wherein the magnetic sensor comprises a magnet and a second evaluation and control unit which has a magnetic sensor element, wherein the magnet is arranged on the at least one coupling apparatus and the second evaluation and control unit is arranged on the at least one circuit carrier in the region of the at least one receiving structure such that the magnetic sensor element of the second evaluation and control unit at least partially overlaps the magnet in the start position of the at least one coupling apparatus.

Certain vehicle functions are woken up or activated when a pedal, in particular a brake pedal, is actuated. This allows the driver to operate the vehicle intuitively, since the brake pedal must be actuated by the driver anyway in order to start the vehicle's engine. Such vehicles can be built without a separate button for starting and stopping the engine. ASICs which evaluate a magnetic field via a Hall sensor are often used for the implementation of the wake-up function. If the magnetic field strength rises or falls past a certain value, the pedal actuation is detected. Since some braking systems are already equipped with a magnet on the brake pedal, the Wake-Up on Pedal function can be easily implemented there.

However, with a wake-up pedal function, the switching point of the function can shift so far that this switching point is already reached without pedal actuation. This should be avoided via the design, but can still occur in individual cases. Possible causes for such a false triggering include, apart from aging of the components involved (mechanical, magnetic and "ASIC" effects), a shift in the pedal's zero position due to a deposit on the pedal's stop (causes permanent slight pedal actuation). The effect of such a shift in the switching point can be seen in the diagram in FIG. 1. The initial state Z0 is a switched-off vehicle in which the Wake-Up on Pedal (WoP) function or the wake-up pedal function still works (and is activated). When the driver performs a pedal actuation PB, this is detected by the Wake-Up on Pedal (WoP) function and the vehicle is "switched on." In this context, "switched on" means that in state Z1 the control devices necessary for driving are awakened or activated. The Wake-Up on Pedal (WoP) function is not active during this phase, because the vehicle's control devices are already activated. After the journey, the driver switches off the vehicle and after a certain time the vehicle “goes to sleep” (sleep ES in FIG. 1), i.e. the control devices of the vehicle shut down from an active mode to a standby mode. If the Wake-Up on Pedal (WoP) function is operational, the vehicle will remain in this state Z2 until the driver actuates the pedal again. However, if the switching point of the Wake-Up on Pedal (WoP) function is shifted in such a way that a pedal actuation is (erroneously) detected even without action on the part of the driver (erroneous detection of a pedal actuation fE PB in FIG. 1), an unwanted endless loop DL (deadlock) occurs, as shown in FIG. 1. Waking up via the Wake-Up on Pedal (WoP) function activates the control devices of the vehicle, whereas the absence of the driver causes the control devices to subsequently be deactivated again. This process can be repeated any number of times. In addition to the undesirable frequent changes in state, this also results in higher power consumption which can lead to the battery of the vehicle being drained.

### SUMMARY

According to a first aspect, the present disclosure provides a method for providing a wake-up pedal function for a vehicle. According to an example embodiment, the method comprises the following steps:

detecting whether a switching command for switching on control devices of the vehicle, triggered by a wake-up pedal function of a pedal, is based on an actuation of the pedal by a driver of the vehicle; and

calibrating the wake-up pedal function if it is detected that the triggered switching command is not based on an actuation of the pedal by the driver of the vehicle.

The method according to the present disclosure can be implemented using hardware and/or software components.

The method according to the present disclosure makes it possible to ensure the wake-up pedal function, or the Wake-Up on Pedal (WoP) function, over the entire service life of a vehicle.

The method according to the present disclosure substantially comprises two main steps, namely the detection of a fault which manifests itself by a cyclical, continuous sleeping and waking of the vehicle, and the elimination of this fault by recalibrating the wake-up pedal function.

The method according to the present disclosure avoids the undesirable frequent changes of state in the control devices due to a faulty wake-up pedal function and the associated high power consumption.

In one possible example embodiment of the method according to the present disclosure for providing a wake-up pedal function for a vehicle, by incrementing a counter value it is counted how often it is detected that a switching command is erroneously triggered to switch on control devices of the vehicle by the wake-up pedal function of a pedal, without the switching command being based on an actuation of the pedal by the driver of the vehicle.

In one possible example embodiment of the method according to the present disclosure for providing a wake-up pedal function for a vehicle, the wake-up pedal function is automatically calibrated if the counter value reaches a threshold value. By setting the threshold value, the method according to the present disclosure can be flexibly adjusted for different applications and wake-up functions.

In one possible example embodiment of the method according to the present disclosure for providing a wake-up pedal function for a vehicle, the calibration of the wake-up pedal function is carried out automatically by adjusting a switching threshold of the wake-up pedal function. This significantly increases the operating life of the wake-up pedal function despite the aging of the components.

In one possible example embodiment of the method according to the present disclosure for providing a wake-up pedal function for a vehicle, an error message is issued in a display unit of a user interface of the vehicle as soon as it is repeatedly detected that the triggered switching command is not based on an actuation of the pedal by the driver of the vehicle. This gives the driver or owner of the vehicle the option of having the wake-up pedal function recalibrated by an automobile repair shop.

In one possible example embodiment of the method according to the present disclosure for providing a wake-up pedal function for a vehicle, the control devices of the vehicle are automatically switched from a standby mode to an active mode after receiving the switching command triggered by the wake-up pedal function.

In one possible example embodiment of the method according to the present disclosure for providing a wake-up pedal function for a vehicle, the control devices of the vehicle are automatically reset from the active mode to the standby mode after a predetermined period of time when the pedal is not actuated.

In one possible example embodiment of the method according to the present disclosure for providing a wake-up pedal function for a vehicle, the detection of whether a switching command, triggered by a wake-up pedal function of a pedal, for switching on control devices of the vehicle is based on an actuation of the pedal by a driver of the vehicle is performed by evaluating a time interval between a first time at which the control devices are reset to standby mode and a second time at which the switching command is triggered by the wake-up pedal function.

In one possible example embodiment of the method according to the present disclosure for providing a wake-up pedal function for a vehicle, the detection of whether a switching command, triggered by a wake-up pedal function of a pedal, for switching on control devices of the vehicle is based on an actuation of the pedal by a driver of the vehicle is performed by evaluating a pedal position of the pedal after the triggering of the switching command.

In one possible example embodiment of the method according to the present disclosure for providing a wake-up pedal function for a vehicle, the wake-up pedal function is provided by monitoring a pedal position of a brake pedal of the vehicle. Alternatively, the pedal position of another pedal provided in the vehicle can be monitored.

The present disclosure further provides a system for providing a wake-up pedal function for a vehicle. According to an example embodiment, the system comprises a detection unit designed to detect whether a switching command, triggered by a wake-up pedal function of a pedal, for switching on control devices of the vehicle is based on an actuation of the pedal by a driver of the vehicle; and comprising a calibration unit designed to calibrate the wake-up pedal function if the detection unit detects that the switching command triggered by the wake-up pedal function is not based on an actuation of the pedal by the driver of the vehicle.

The present disclosure further provides a vehicle. According to an example embodiment, the vehicle comprises a pedal which can be actuated by a driver and a system for providing a wake-up pedal function comprising a detection unit designed to detect whether a switching command, triggered by a wake-up pedal function of a pedal, for switching on control devices of the vehicle is based on an actuation of the pedal by a driver of the vehicle; and comprising a calibration unit designed to calibrate the wake-up pedal function if the detection unit detects that the switching command triggered by the wake-up pedal function is not based on an actuation of the pedal by the driver of the vehicle.

In one possible example embodiment, the vehicle is a road vehicle, in particular a car or truck. However, it can also be another vehicle, for example a forklift truck, a train, or an agricultural vehicle.

The above embodiments and developments may be combined with one another in any reasonable manner. Further possible embodiments, developments and implementations of the present disclosure also include combinations not explicitly mentioned of features of the present disclosure described above or in the following relating to the exemplary embodiments. A person skilled in the art will in particular also add individual aspects as improvements or additions to the relevant basic form of the present disclosure, in view of the disclosure herein.

Furthermore, possible embodiments of the method according to the present disclosure and the system according to the present disclosure are described in more detail with reference to the figures.

### BRIEF DESCRIPTION OF THE DRAWINGS

FIG. 1 is a diagram illustrating a technical problem on which the method and system according to the present disclosure are based.

FIG. 2 is a flowchart illustrating a possible embodiment of the method according to the present disclosure for providing a wake-up pedal function for a vehicle.

FIG. 3 is a flowchart illustrating another possible embodiment of the method according to the present disclosure for providing a wake-up pedal function for a vehicle.

FIG. 4 is a schematic block diagram illustrating a possible embodiment of the system according to the present disclosure for providing a wake-up pedal function for a vehicle.

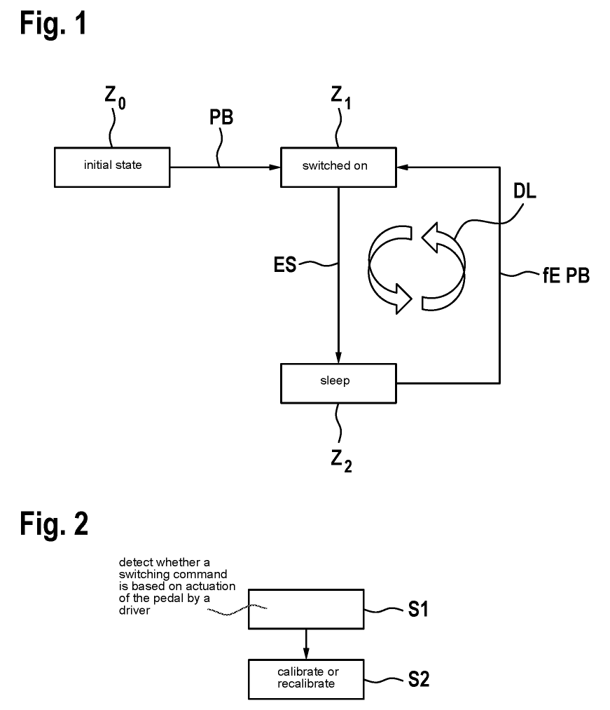

### DETAILED DESCRIPTION OF EXAMPLE EMBODIMENTS

The figures are intended to impart further understanding of the embodiments of the present disclosure. They illustrate embodiments and, in connection with the description, serve to explain principles and concepts of the present disclosure. Other embodiments and many of the mentioned advantages are apparent from the figures. The elements of the figures are not necessarily shown to scale relative to one another.

In the figures, identical, functionally identical and identically acting elements, features and components are in each case provided with the same reference signs, to the extent that nothing else is stated.

According to a first aspect, the present disclosure provides a method for providing a wake-up pedal function for a vehicle F, comprising a plurality of main steps. FIG. 2 is a flowchart of a possible embodiment of the method according to the present disclosure.

In a first step S1, it is detected whether a switching command, which is triggered by a wake-up pedal function of a pedal, for switching on control devices of the vehicle is actually based on an actuation of the pedal by a driver of the vehicle. The control device is, for example, an engine control device for an electric or combustion engine of the vehicle.

In a first possible embodiment of the method according to the present disclosure for providing a wake-up pedal function for a vehicle, in step S1 the detection of whether a switching command, triggered by a wake-up pedal function of a pedal, for switching on control devices of the vehicle is based on an actuation of the pedal by a driver of the vehicle is performed by evaluating a time interval between a first time at which the control devices of the vehicle are reset to standby mode and a second time at which the switching command is triggered by the wake-up pedal function.

In the first embodiment, the error is detected in step S1 by taking the temporal sequence into account. If the switching on immediately (e.g. within 1 s) follows the switching off, it is unlikely that the driver was the cause. The temporal sequence can be ascertained, for example, by taking the clock time into account or by another mechanism of the control device.

In a further, second possible embodiment of the method according to the present disclosure for providing a wake-up pedal function for a vehicle, in step S1 the detection of whether a switching command, triggered by a wake-up pedal function of a pedal, for switching on control devices of the vehicle is based on an actuation of the pedal by a driver of the vehicle is performed by evaluating a pedal position of the pedal after the triggering of the switching command.

In the second embodiment of the method according to the present disclosure, the error is detected in step S1 by evaluating the pedal position after the switching on. When the device is switched on, the measuring technology for ascertaining the pedal position also becomes active after a slight delay. This makes it possible to determine whether the pedal is actuated immediately after the wake-up impulse. If this is not the case, it is very unlikely that the driver caused the wake-up.

The two embodiments described above for detecting the error in step S1 can also be combined.

In a second step S2 of the method according to the present disclosure, the wake-up pedal function is calibrated or recalibrated if it is detected at least once in step S1 that the triggered switching command is not based on an actuation of the pedal by the driver of the vehicle.

To eliminate the error detected in step S1, a recalibration of the wake-up pedal function or WoP function can be performed in step S2. This adjusts the switching point to the current conditions. In one possible embodiment, the switching point is set to the ideal nominal switching point using a measurement. However, the switching point can also be changed without measurement by raising the switching threshold by a defined value.

Alternatively or in addition to performing an automatic recalibration in step S2, an error message can also be issued in a user interface display. The driver can then have their vehicle recalibrated by a specialist company, or they can replace the defective device.

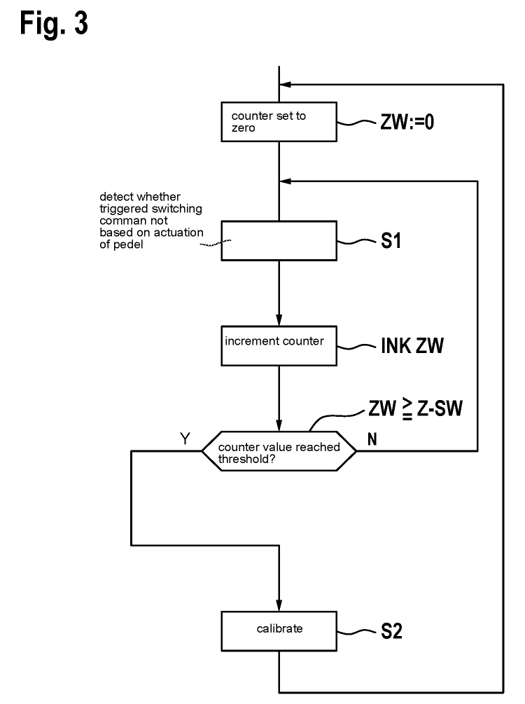

As shown in the flowchart according to FIG. 3, in a possible embodiment of the method according to the present disclosure for providing a wake-up pedal function for a vehicle, by incrementing (INK) a counter value ZW of a counter Z it is counted how often it is detected in step S1 that a switching command is erroneously triggered to switch on control devices of the vehicle by the wake-up pedal function of a pedal, without the switching command being based on an actuation of the pedal by the driver of the vehicle. The wake-up pedal function is automatically calibrated in step S2 as soon as the counter value ZW of the counter Z reaches a counter threshold value Z-SW (ZW >= Z-SW). In one possible implementation, the counter threshold value can be set. In another possible embodiment, the speed at which the counter value ZW changes per unit of time is also calculated. This allows conclusions to be drawn about the cause of the error detected in step S1.

In the embodiment shown in FIG. 3, it is detected that the current switching on was probably not caused by the driver, and it is counted how many times in succession such an erroneous switching on was detected. After a defined number of accepted errored switchings on (for example Z-SW=3), the malfunction is considered detected and the countermeasure is initiated in step S2.

In one possible embodiment of the method according to the present disclosure for providing a wake-up pedal function for a vehicle, the calibration of the wake-up pedal function is carried out automatically in step S2 by adjusting a switching threshold WoP-SW of the wake-up pedal function (WoP). In step S2, in one possible implementation, an error message is additionally issued in a display unit of a user interface of the vehicle as soon as it is repeatedly detected in step S1 that the triggered switching command is not based on an actuation of the pedal by the driver of the vehicle.

In one possible embodiment of the method according to the present disclosure for providing a wake-up pedal function for a vehicle, the control devices of the vehicle are automatically switched from a standby mode to an active mode after receiving the switching command triggered by the calibrated wake-up pedal function. If the pedal is not actuated, the control units of the vehicle are automatically reset from active mode to standby mode after a predetermined period of time.

In one possible embodiment of the method according to the present disclosure for providing a wake-up pedal function for a vehicle, the wake-up pedal function is provided by monitoring a pedal position of a brake pedal of the vehicle.

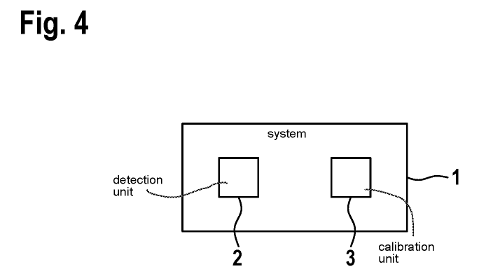

The present disclosure further provides a system 1 for providing a wake-up pedal function (WoP) for a vehicle as shown schematically in FIG. 4. The system 1 comprises a detection unit 2 designed to detect whether a switching command, triggered by a wake-up pedal function (WoP) of a pedal, for switching on control devices of the vehicle is actually based on an actuation of the pedal by a driver of the vehicle. The system 1 further comprises a calibration unit 3 designed to calibrate the wake-up pedal function if the detection unit 2 detects that the switching command triggered by the wake-up pedal function is not based on an actuation of the pedal by the driver of the vehicle.

The present disclosure further provides a vehicle F comprising a pedal which can be actuated by a driver and a system 1 for providing a wake-up pedal function comprising a detection unit 2 designed to detect whether a switching command, triggered by a wake-up pedal function of a pedal, for switching on control devices of the vehicle is based on an actuation of the pedal by a driver of the vehicle; and comprising a calibration unit 3 designed to calibrate the wake-up pedal function if the detection unit 2 of the system 1 detects that the switching command triggered by the wake-up pedal function is not based on an actuation of the pedal by the driver of the vehicle F.

Although the present disclosure has been completely described above with reference to preferred exemplary embodiments, it is not limited thereto, but can be modified in many ways.

What is claimed is:

1. A method for providing a wake-up pedal function for a vehicle, comprising the following steps:
detecting whether a switching command for switching on control devices of the vehicle, triggered by a wake-up pedal function of a pedal, is based on an actuation of the pedal by a driver of the vehicle; and
calibrating the wake-up pedal function when it is detected that the triggered switching command is not based on an actuation of the pedal by a driver of the vehicle.

2. The method according to claim 1, further comprising:
incrementing a counter value to count how often it is detected that the switching command is erroneously triggered to switch on control devices of the vehicle by the wake-up pedal function of a pedal, without the switching command being based on an actuation of the pedal by the driver of the vehicle.

3. The method according to claim 2, wherein the wake-up pedal function is automatically calibrated when the counter value reaches a threshold value.

4. The method according to claim 1, wherein the calibration of the wake-up pedal function is performed automatically by adjusting a switching threshold of the wake-up pedal function.

5. The method according to claim 1, wherein an error message is issued in a display unit of a user interface of the vehicle when it is repeatedly detected that the triggered switching command is not based on an actuation of the pedal by the driver of the vehicle.

6. The method according to claim 1, wherein the control devices of the vehicle are automatically switched from a standby mode to an active mode after receiving the switching command triggered by the wake-up pedal function.

7. The method according to claim 6, wherein the control devices of the vehicle are automatically reset from the active mode to the standby mode after a predetermined period of time when the pedal is not actuated.

8. The method according to claim 7, wherein the detection of whether the switching command, triggered by the wake-up pedal function of the pedal, for switching on the control devices of the vehicle is based on an actuation of the pedal by a driver of the vehicle is performed by evaluating a time interval between a first time at which the control devices are reset to standby mode and a second time at which the switching command is triggered by the wake-up pedal function.

9. The method according to claim 1, wherein the detection of whether the switching command, triggered by the wake-up pedal function of the pedal, for switching on the control devices of the vehicle is based on an actuation of the pedal by a driver of the vehicle is performed by evaluating a pedal position of the pedal after the triggering of the switching command.

10. The method according to claim 1, wherein the wake-up pedal function is provided by monitoring a pedal position of a brake pedal of the vehicle.

11. A system for providing a wake-up pedal function for a vehicle, comprising:
a detection unit configured to detect whether a switching command, triggered by a wake-up pedal function of a pedal, for switching on control devices of the vehicle is based on an actuation of the pedal by a driver of the vehicle; and
a calibration unit configured to calibrate the wake-up pedal function if the detection unit detects that the switching command triggered by the wake-up pedal function is not based on an actuation of the pedal by the driver of the vehicle.

12. A vehicle, comprising:
a pedal which can be actuated by a driver; and
a system for providing a wake-up pedal function including:
a detection unit configured to detect whether a switching command, triggered by a wake-up pedal function of the pedal, for switching on control devices of the vehicle is based on an actuation of the pedal by the driver of the vehicle, and
a calibration unit configured to calibrate the wake-up pedal function if the detection unit detects that the switching command triggered by the wake-up pedal function is not based on an actuation of the pedal by the driver of the vehicle.
